(19) United States
(12) Patent Application Publication
(10) Pub. No.: US 2025/0392448 A1
(43) Pub. Date: Dec. 25, 2025

(54) ENCRYPTED DATA TRANSMISSION METHOD UTILIZING FM RADIO SIGNALS FOR SECURE ACCESS

(71) Applicant: DISH Wireless L.L.C., Englewood, CO (US)

(72) Inventors: Siddhartha CHENUMOLU, Ashburn, VA (US); Mehdi ALASTI, Arlington, VA (US)

(73) Assignee: DISH Wireless L.L.C., Englewood, CO (US)

(21) Appl. No.: 18/641,870

(22) Filed: Apr. 22, 2024

(51) Int. Cl. H04L 9/08; H04L 9/30

(52) U.S. Cl. CPC H04L 9/0825; H04L 9/30

(57) ABSTRACT

The method and system for transmitting data involves the use of a FM radio signal to transmit a data stream. The data stream is embedded in the FM radio signal and is encrypted using an encryption key. The encrypted data stream is then decoded using a decryption key, allowing an authorized user to access the data stream. The data stream can be a security feed, and the authorized user can be an emergency responder such as a firefighter, policeperson, or EMT. The system also includes a device for transmitting and receiving the radio signal. The teachings provide a secure and efficient means of transmitting data over FM radio signals, ensuring confidentiality and accessibility for authorized users.

### FIELD

The present teachings disclose use of FM broadcast signals for the transmission of encrypted security feeds to emergency responders.

### BACKGROUND

In the realm of emergency response, communication is a vital aspect. Emergency responders such as firefighters, police officers, and emergency medical technicians (EMTs) often rely on various forms of communication to receive critical information that can aid in their response efforts. One such form of communication is through broadcast signals. Cellular signals, however, may not always be reliable or secure, potentially compromising the effectiveness of the emergency response. Furthermore, these signals may not penetrate deeply or work at high power, limiting their reach and effectiveness. Therefore, there is a need for a more reliable and secure form of communication that can penetrate deeply and work at high power, enhancing the effectiveness of emergency response efforts.

Previous approaches for transmitting data have involved various methods and techniques to ensure secure and efficient transmission. FM radio signals have been widely used for broadcasting audio signals and associated data. In some previous approaches associated data has been embedded within FM radio signals to enable simultaneous transmission of audio and data. This approach has often faced challenges in terms of data capacity and signal quality, as the available bandwidth within the FM radio signal is limited.

To address the need for secure transmission, encryption techniques have been employed in previous approaches. These techniques involve encrypting the data stream using an encryption key, which scrambles the data to prevent unauthorized access. Decryption keys are then used to decode the encrypted data stream at the receiving end, allowing authorized users to access the original data. Various encryption algorithms and protocols have been utilized in previous approaches to ensure the confidentiality and integrity of the transmitted data.

The embedding of data streams within FM radio signals has faced challenges in achieving high data rates, securing the data streams from unauthorized users and maintaining signal fidelity. Therefore, there is a need for a comprehensive solution that combines efficient data transmission, secure encryption, and reliable access for authorized users. However, none of these approaches have provided a comprehensive solution that combines the features described in this disclosure.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

The present teachings provide secure transmission of mission critical data, such as, a security feed. An FM broadcast signal is used to transmit a security feed using a public encryption key associated with a user's private key. FM works best because it penetrates deeply and works at high power. The security feed is embedded in the FM broadcast signal to reach an emergency responder, such as, a firefighter, a policeperson, an EMT or the like. When the emergency responder needs access to the security feed, the encrypted security feed can be decoded using the associated private key. Only the emergency responder with the associated private key can decode the security feed. The security feed can be periodically updated, a different feed maybe sent periodically (time multiplexed), and also based on geographic locations.

In some aspects, the techniques described herein relate to a method for securely transmitting data, the method including: encrypting a data stream using an encryption key; embedding the encrypted data stream in an FM (Frequency Modulated) radio signal; and transmitting the encrypted data stream using the FM radio signal.

In some aspects, the techniques described herein relate to a method, wherein the data stream is a security feed.

In some aspects, the techniques described herein relate to a method, wherein the FM radio signal includes other FM content.

In some aspects, the techniques described herein relate to a method, wherein the data stream includes a symmetric key to decrypt a security feed.

In some aspects, the techniques described herein relate to a method, wherein the encryption key is a public encryption key associated with a user's private key.

In some aspects, the techniques described herein relate to a method, further including: receiving the FM radio signal; decoding the encrypted data stream embedded in the FM radio signal using a decryption key; and accessing the data stream.

In some aspects, the techniques described herein relate to a method, wherein the accessing is performed by an authorized emergency responder.

In some aspects, the techniques described herein relate to a method, wherein the authorized emergency responder includes one or more of a firefighter, a policeperson or an Emergency Medical Technician.

In some aspects, the techniques described herein relate to a method, wherein the decryption key is a user's private key associated with the encryption key.

In some aspects, the techniques described herein relate to a method, wherein the receiving, the decoding and the accessing is performed on a mobile device.

In some aspects, the techniques described herein relate to a system to securely transmit data, the system including: an encryptor to encrypt a data stream using an encryption key; an embedder to embed the encrypted data stream in an FM (Frequency Modulated) radio signal; and an FM transmitter to transmit the encrypted data stream using the FM radio signal. The stream may also be sent over different FM frequencies, simultaneously or utilizing a known frequency hopping sequence.

In some aspects, the techniques described herein relate to a system, wherein the data stream is a security feed.

In some aspects, the techniques described herein relate to a system, wherein the FM radio signal includes other FM content.

In some aspects, the techniques described herein relate to a system, wherein the data stream includes a symmetric key to decrypt a security feed.

In some aspects, the techniques described herein relate to a system, wherein the encryption key is a public encryption key associated with a user's private key.

In some aspects, the techniques described herein relate to a system, further including: an FM receiver to receive the FM radio signal; a decoder to decode the encrypted data stream embedded in the FM radio signal using a decryption key; and a user access component to access the data stream.

In some aspects, the techniques described herein relate to a system, wherein the user access component is used by an authorized emergency responder.

In some aspects, the techniques described herein relate to a system, wherein the authorized emergency responder includes one or more of a firefighter, a policeperson or an Emergency Medical Technician.

In some aspects, the techniques described herein relate to a system, wherein the decryption key is a user's private key associated with the encryption key.

In some aspects, the techniques described herein relate to a system, wherein the FM receiver, the decoder and the user access component are disposed in a mobile device.

Additional features will be set forth in the description that follows, and in part will be apparent from the description, or may be learned by practice of what is described.

### DRAWINGS

In order to describe the manner in which the above-recited and other advantages and features may be obtained, a more particular description is provided below and will be rendered by reference to specific embodiments thereof which are illustrated in the appended drawings. Understanding that these drawings depict only typical embodiments and are not, therefore, to be limiting of its scope, implementations will be described and explained with additional specificity and detail with the accompanying drawings.

FIG. 1 illustrates, in a flowchart, operations for securely transmitting a data stream using FM radio signal in accordance with certain embodiments.

FIG. 2 illustrates, in a block diagram, the main components of the Secure FM Broadcast System in accordance with certain embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The present teachings may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

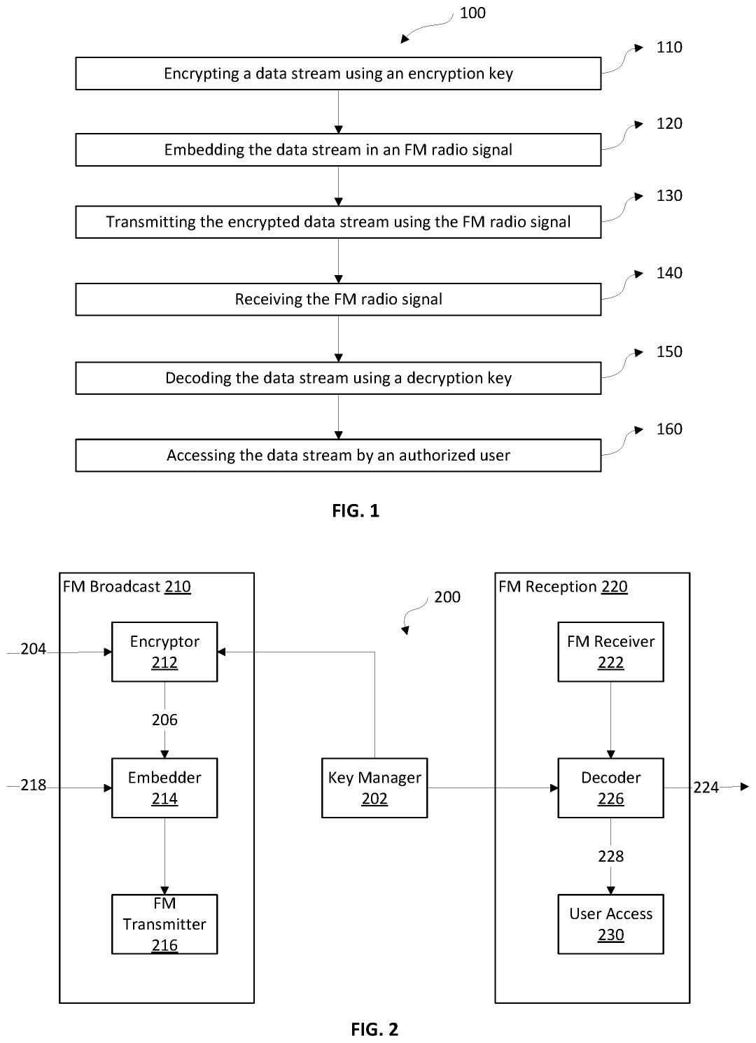

FIG. 1 illustrates, in a flowchart, a method for securely transmitting a data stream using FM radio signal in accordance with certain embodiments.

FIG. 1 is a flowchart of an example method for securely transmitting a data stream using an FM radio signal.

At operation 110, the method 100 includes securing a data stream by encrypting the data stream using an encryption key. The encrypting transforms the data stream into an encrypted format using a specific key. An encryption algorithm alters the data stream into a format that is not readily interpretable without the corresponding key for decryption.

The encryption key may be a symmetric or an asymmetric encryption key. In symmetric encryption, the same key is used for encrypting and decrypting. For asymmetric encryption, a key pair including a public key and a private key held by a user. Generally, the public key is used for encryption and the private key is used for decryption, where the public and private keys are different. The public key is designed to encrypt data in such a way that it can only be decrypted by the matching private key.

The public key is associated with a user's private key. This association is part of a system that ensures that the data, once encrypted, can only be decrypted and accessed by the holder of the private key. The use of this key pair allows for the secure transmission of the data stream over channels that are not inherently secure, such as FM radio signals.

The encrypted data stream is then ready for embedding into the FM radio signal (operation 120) and subsequent transmission (operation 130). A receiver of the data stream, who possesses the private key, can receive the encrypted stream (operation 140) then use it to decrypt the data stream (operation 150). This process ensures that the data can be accessed exclusively by an authorized or intended recipient equipped with the necessary private key to decode the encrypted data. In some embodiments, the accessing may be limited to an authorized time. The system is designed to provide a secure method of transmitting sensitive information in controlled manner, such as a security feed, to users who possess the associated private key.

At operation 120, the method 100 includes integrating a data stream into an FM radio signal by embedding the data stream in an FM radio signal. This ensures that the data stream, which may be a security feed, is transmitted over the FM broadcast signal to reach an authorized or designated recipient, such as an emergency responder.

In some embodiments, the embedding combines the encrypted security feed with other FM broadcast content in a manner that allows both to coexist without interference. The security feed source generates the data to be transmitted, and the FM broadcasting equipment processes this data to make it compatible with the FM radio signal. The integration of the FM signal may be achieved through multiplexing the security feed with the other FM broadcast content or by using a subcarrier within the FM signal's frequency spectrum. The other FM content may be an audio signal. The FM radio signal then carries the integrated security feed over distances to the emergency responders.

By embedding the security feed into the FM radio signal, the security feed can be accessed by emergency responders in various conditions. The robust nature of the FM signal makes it a suitable carrier for information that needs to be accessed quickly and securely by authorized personnel during emergencies in locations where a deep penetrative signal is needed. FM signals, unlike cellular signals of the Fourth Generation (4G), Fifth Generation (5G) or the like, are deeply penetrative and robust.

At operation 130, the method 100 includes transmitting the encrypted data stream using the FM radio signal. The FM radio signal ensures that the signal reaches emergency responders effectively, even under challenging conditions. An FM transmitter sends out the FM radio signal. The FM transmitter modulates the encrypted security feed onto the FM radio frequency, allowing the signal to be carried over distances. The modulation process involves varying the frequency of the carrier wave in accordance with the information in the security feed. This ensures that the data stream can be transmitted and can be demodulated by a FM receiver.

FM transmission is resilient to noise and interference, which makes it a reliable medium for communications needed by emergency responders. The transmission device handles the necessary power levels and frequency ranges to ensure the signal's integrity and coverage.

In some embodiments, a broadcasting station equipped with an FM transmitter may send out the encrypted security feed. The station would embed the security feed into the FM signal. In some embodiments, encryption equipment to secure the data before transmission may be housed at the station. In some embodiments, the encryption equipment may be disposed remote from the station, and the encrypted security feed may be received by the station. In some embodiments, the FM antenna and FM broadcast equipment may be co-hosted with a cellular base station. The transmission may be directed towards areas where emergency responders require access to the security feed for their operations.

At operation 140, the method 100 may include receiving the FM radio signal with a FM receiver. The FM receiver may be disposed in a mobile device such as a cellular phone, a satellite phone, or the like.

At operation 150, the method 100 may include decoding the data stream that has been previously encrypted and transmitted using an FM radio signal. The decoding is accomplished through the use of a decryption key. This key may be unique and private, ensuring that only an authorized user with the corresponding key can revert the data stream back to its original, intelligible form. The decryption may be performed on a mobile device that works in conjunction with the symmetric key for symmetric encryption or the associated private key for asymmetric encryption to unlock the encrypted content.

For asymmetric decryption, the decryption key utilized in the decoding process is the private key of the user paired with the public key that was used to encrypt the data stream. The public key may be openly distributed, while the private key may be securely provided to authorized users to decrypt data. During the decoding process, the user's device employs the private key to interpret the encrypted signals received over the FM radio frequency. The decryption outputs the original data stream, for example, a security feed that can be accessed by users such as emergency responders. This process allows for the secure and exclusive delivery of sensitive information over a commonly accessible medium.

At operation 160, the method 100 includes accessing the data stream by an authorized user. The user in this context may be an emergency responder who is equipped with a device capable of receiving FM signals and decrypting the data stream. The user may be an emergency responder in general, for example, a firefighter, a policeperson, an Emergency Medical Technician, or the like. Each of these users must have the key that matches the key used during the encryption process to ensure secure access to the data stream.

The device used by the user must have the capability to both receive the FM signal and apply the decryption algorithm using the private key. This process allows the user to access the security feed that has been transmitted. The transmission, encryption, and decryption of the data stream are designed to maintain the confidentiality and accessibility of the information for users who are authorized and equipped to receive it. The structure of this system ensures that the data stream remains secure during transmission and is only accessible to users with the appropriate credentials.

A Secure FM Broadcast System 200 is designed to transmit sensitive data securely over FM radio signals. This system may be tailored for emergency responders, providing them with a method to access real-time security feeds during emergencies. The system's ability to penetrate with high-powered FM signals ensures that the data reaches its intended recipients. The Secure FM Broadcast System 200 includes several components and sub-components that work together to facilitate the secure transmission and reception of encrypted data streams via FM radio signals.

The secure FM broadcast system 200 may include a key manager 202, an FM broadcast component 210 and an FM reception component 220. The key manager 202 may manage key pairs and their associations for asymmetric keys, where the public key is used for encryption and the associated private key is used for decryption.

The FM Broadcast component 210 is responsible for the transmission the FM radio signal that carries a data stream 204. It serves as a primary interface between the system and the airwaves. The FM broadcast component 210 handles encrypting a data stream 204, for example, a security feed, embedding the encrypted data stream 206 within an FM signal and transmitting the FM signal including sensitive information (such as the security feed) for emergency responders.

The FM broadcast component 210 includes an encryptor 212 to encrypt a data stream using a symmetric key or a public encryption key of a key pair. The encryptor 212 may be deployed at a broadcast station, or may be deployed remote from the broadcast station. The encryptor 212 analogous to operation 110. A complementary decoder 226, analogous to operation 150, may be disposed in FM reception component 220 to decrypt the data stream using the symmetric key or a corresponding private key of the key pair.

FM broadcast component 210 includes an embedder 214 to integrate an encrypted data stream with an FM signal analogous to operation 120. In some embodiments, embedder 214 may integrate, by multiplexing or the like, the encrypted data stream with other FM content 218. Other FM content 218 may be audio signal. FM reception component 220 may include a complementary component, a decoder 226 analogous to operation 150. The complementary decoder 226 outputs a decrypted data stream 228 for a user access component 230. Complementary decoder 226 may output other FM content 224.

The User Access component 230 defines the interface for authorized users to access the encrypted data stream. It ensures that only those with the correct private key can decode and view the security feed. User access component 230 may provide specialized access points for emergency responders based on their jobs, for example, firefighters, police officers, and EMTs, respectively, enabling them to access the security feed pertinent to their emergency response activities.

Having described preferred embodiments of a system and method (which are intended to be illustrative and not limiting), it is noted that modifications and variations can be made by persons skilled in the art considering the above teachings. It is therefore to be understood that changes may be made in the embodiments disclosed which are within the scope of the invention as outlined by the appended claims. Having thus described aspects of the invention, with the details and particularity required by the patent laws, what is claimed and desired protected by Letters Patent is set forth in the appended claims.

We claim as our invention:

1. A method for securely transmitting data, the method comprising:
encrypting a data stream using an encryption key;
embedding the encrypted data stream in an FM (Frequency Modulated) radio signal; and
transmitting the encrypted data stream using the FM radio signal.

2. The method of claim 1, wherein the data stream is a security feed.

3. The method of claim 1, wherein the FM radio signal comprises other FM content.

4. The method of claim 1, wherein the data stream comprises a symmetric key to decrypt a security feed.

5. The method of claim 1, wherein the encryption key is a public encryption key associated with a user's private key.

6. The method of claim 1, further comprising:
receiving the FM radio signal;
decoding the encrypted data stream embedded in the FM radio signal using a decryption key; and
accessing the data stream.

7. The method of claim 6, wherein the accessing is performed by an authorized emergency responder.

8. The method of claim 7, wherein the authorized emergency responder comprises one or more of a firefighter, a policeperson or an Emergency Medical Technician.

9. The method of claim 6, wherein the decryption key is a user's private key associated with the encryption key.

10. The method of claim 6, wherein the receiving, the decoding and the accessing is performed on a mobile device.

11. A system to securely transmit data, the system comprising:
an encryptor to encrypt a data stream using an encryption key;
an embedder to embed the encrypted data stream in an FM (Frequency Modulated) radio signal; and
an FM transmitter to transmit the encrypted data stream using the FM radio signal.

12. The system of claim 11, wherein the data stream is a security feed.

13. The system of claim 11, wherein the FM radio signal comprises other FM content.

14. The system of claim 11, wherein the data stream comprises a symmetric key to decrypt a security feed.

15. The system of claim 11, wherein the encryption key is a public encryption key associated with a user's private key.

16. The system of claim 11, further comprising:
an FM receiver to receive the FM radio signal;
a decoder to decode the encrypted data stream embedded in the FM radio signal using a decryption key; and
a user access component to access the data stream.

17. The system of claim 16, wherein the user access component is used by an authorized emergency responder.

18. The system of claim 17, wherein the authorized emergency responder comprises one or more of a firefighter, a policeperson or an Emergency Medical Technician.

19. The system of claim 16, wherein the decryption key is a user's private key associated with the encryption key.

20. The system of claim 16, wherein the FM receiver, the decoder and the user access component are disposed in a mobile device.
